(19) United States
(12) Patent Application Publication
(10) Pub. No.: US 2025/0233435 A1
(43) Pub. Date: Jul. 17, 2025

(54) CHARGING CONTROL SYSTEM AND CHARGING CONTROL METHOD

(71) Applicant: TOYOTA JIDOSHA KABUSHIKI KAISHA, Toyota-shi Aichi-ken (JP)

(72) Inventor: Yuko YANAGAWA, Toyota-shi Aichi-ken (JP)

(73) Assignee: TOYOTA JIDOSHA KABUSHIKI KAISHA, Toyota-shi Aichi-ken (JP)

(21) Appl. No.: 19/013,127

(22) Filed: Jan. 8, 2025

(30) Foreign Application Priority Data
Jan. 15, 2024 (JP) 2024-003919

(51) Int. Cl. H02J 7/00; B60L 53/62; B60L 58/16

(52) U.S. Cl. CPC H02J 7/005; B60L 53/62; B60L 58/16

(57) ABSTRACT

A charging control system according to an aspect of the present disclosure includes: a charging apparatus for charging a battery electric vehicle; and a control apparatus for controlling charging of a plurality of the battery electric vehicles by the charging apparatus. The control apparatus includes: a deterioration information acquisition unit configured to acquire high-rate deterioration information of a battery provided by each of the plurality of the battery electric vehicles; and a priority determination unit configured to determine a charging priority of each of the plurality of the battery electric vehicles based on the high-rate deterioration information acquired by the deterioration information acquisition unit. The higher high-rate deterioration degree of an overdischarging type in the battery is, the higher a charging priority is given to the battery electric vehicle provided with the battery by the priority determination unit.

### CROSS REFERENCE TO RELATED APPLICATIONS

This application is based upon and claims the benefit of priority from Japanese patent application No. 2024-003919, filed on Jan. 15, 2024, the disclosure of which is incorporated herein in its entirety by reference.

### BACKGROUND

The present disclosure relates to a charging control system and a charging control method.

For example, Patent Literature 1 discloses a charging control system for controlling charging of a plurality of BEVs (hereinafter referred to as battery electric vehicles). Incidentally, for example, a virtual power plant in which a plurality of battery electric vehicles parked for a certain period of time are charged electricity from a power system and then power is supplied to the power system from the plurality of battery electric vehicles that have been electrically charged. In such an application, when charging electricity to a plurality of battery electric vehicles from a power system, the order of charging can be arbitrarily determined. For example, the order of charging can be determined in consideration of the deterioration of the batteries of the vehicles.

Here, as disclosed in, for example, Patent Literature 2, transient high-rate deterioration caused by charging and discharging a large current is known as an example of deterioration of a battery. That is, there are two types of high-rate deterioration: overcharging and overdischarging. In the case of overcharging, progression in deterioration of a battery occurs due to charging. On the other hand, in the case of overdischarging, high-rate deterioration due to charging is alleviated.
Patent Literature 1: Japanese Unexamined Patent Application Publication No. 2011-130575
Patent Literature 2: Japanese Unexamined Patent Application Publication No. 2019-156229

### SUMMARY

In the charge control system disclosed in Patent Literature 1, since no consideration is given to the deterioration of the battery, especially high-rate deterioration, there is a possibility that a battery that has been high-rate deteriorated, the deterioration being an overcharging type, is also charged causing progression in the deterioration of the battery due to high-rate deterioration.

The present disclosure has been made in view of such circumstances, and provides a charging control system capable of alleviating high-rate deterioration of a battery.

According to an aspect of the present disclosure, a charging control system includes:
a charging apparatus for charging a battery electric vehicle; and
a control apparatus for controlling charging of a plurality of the battery electric vehicles by the charging apparatus,
in which the control apparatus includes:
a deterioration information acquisition unit configured to acquire high-rate deterioration information of a battery provided by each of the plurality of the battery electric vehicles; and
a priority determination unit configured to determine a charging priority of each of the plurality of the battery electric vehicles based on the high-rate deterioration information acquired by the deterioration information acquisition unit,
in which the higher the high-rate deterioration degree of an overdischarging type in the battery is, the higher a charging priority is given to the battery electric vehicle provided with the battery by the priority determination unit.

In a charging control system according to the present disclosure, the control apparatus includes a deterioration information acquisition unit configured to acquire high-rate deterioration information of a battery provided by each of the plurality of the battery electric vehicles; and a priority determination unit configured to determine a charging priority of each of the plurality of the battery electric vehicles based on the high-rate deterioration information acquired by the deterioration information acquisition unit.

The higher the high-rate deterioration degree of an overdischarging type in the battery is, the higher a charging priority is given to the battery electric vehicle provided with the battery by the priority determination unit gives.

That is, the battery that has been high-rate deteriorated, the deterioration being an overcharging type, is less apt to be charged, and the battery that has been high-rate deteriorated, the deterioration being an overdischarging type, is preferentially charged. Therefore, a charging control system capable of alleviating high-rate deterioration of the battery can be provided.

The deterioration information acquisition unit may further acquire SOH (State of Health) information of the battery, and when the charging priorities based on the high-rate deterioration degrees are the same the priority determination unit may give a higher charging priority to the battery electric vehicle provided with the battery having a higher SOH. By using a battery having a high SOH, the SOH of the batteries in a plurality of the battery electric vehicles can be leveled.

The charging apparatus may be connected to a power system, and a plurality of the battery electric vehicles charged by the charging apparatus may constitute a virtual power plant capable of supplying power to the power system. The charging control system according to the present disclosure is suitable for such an application.

According to an aspect of the present disclosure, a charging control method for causing a computer to control charging of a plurality of battery electric vehicles, includes:
acquiring high-rate deterioration information of a battery provided by each of the plurality of the battery electric vehicles; and
determining a charging priority of each of the plurality of the battery electric vehicles based on the acquired high-rate deterioration information,
in which in determining the charging priority, the higher the high-rate deterioration degree of an overdischarging type in the battery is, the higher a charging priority is given to the battery electric vehicle provided with the battery by the priority determination unit.

According to an aspect of the present disclosure, a charging control method according to the present disclosure includes: acquiring high-rate deterioration information of a battery provided by each of the plurality of the battery electric vehicles; and determining a charging priority of each of the plurality of the battery electric vehicles based on the acquired high-rate deterioration information. In determining the charging priority, the higher the high-rate deterioration degree of an overdischarging type in the battery is, the higher a charging priority is given to the battery electric vehicle provided with the battery by the priority determination unit.

That is, the battery that has been high-rate deteriorated, the high-rate deterioration being an overcharging type, is less apt to be charged, and the battery that has been high-rate deteriorated, the high-rate deterioration being an overcharging type, is preferentially charged. Therefore, it is possible to alleviate high-rate deterioration in the battery.

According to the present disclosure, a charging control system adapted to alleviate high-rate deterioration of a battery can be provided.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a charging control system according to a first embodiment;

FIG. 2 is a schematic plan view of a parking lot to which the charging control system according to the first embodiment is applied;

FIG. 3 is a side view schematically showing charging of a battery electric vehicle EV1 parked in a parking space P11 using a charging and discharging apparatus CD1; and

FIG. 4 is a flowchart showing a charging control method according to the first embodiment.

### DESCRIPTION OF EMBODIMENTS

Hereinafter, specific embodiments of the present disclosure will be described in detail with reference to the drawings. However, the present disclosure is not limited to the following embodiments. In order to clarify the description, the following description and drawings are simplified as appropriate.

### First Embodiment

### <Configuration of Charging Control System>

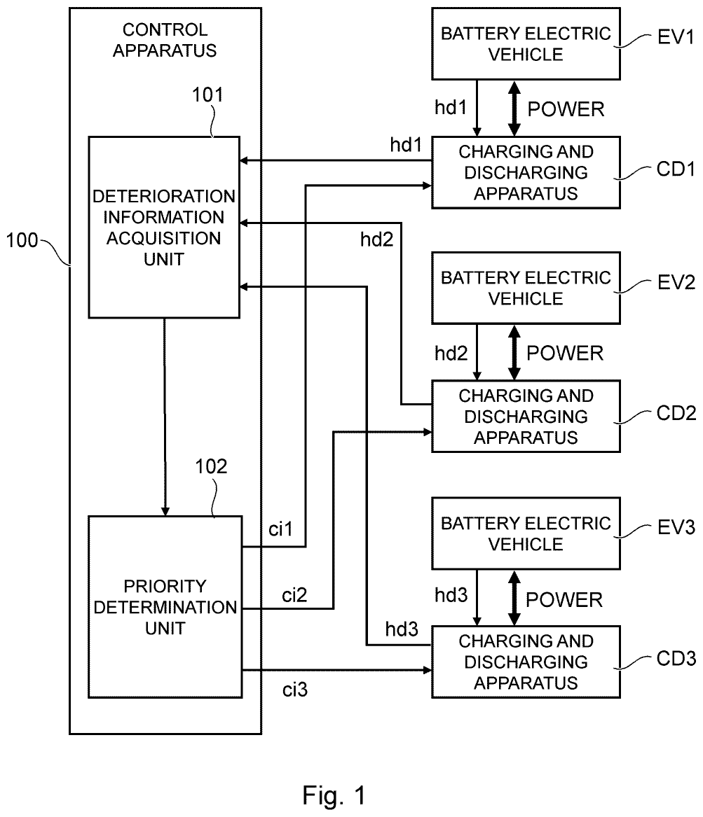

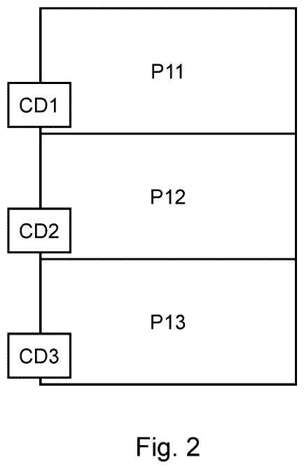

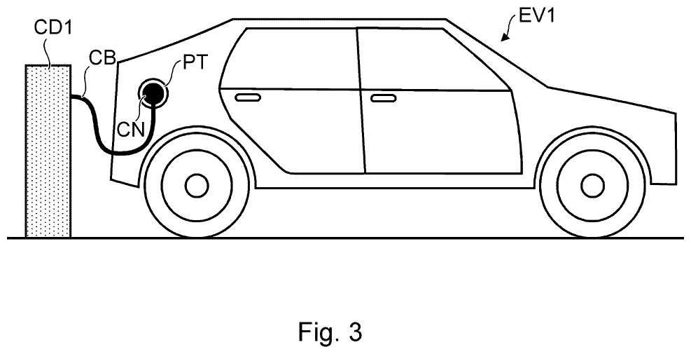

First, a configuration of a charging control system according to a first embodiment will be described with reference to FIGS. 1 to 3. FIG. 1 is a block diagram showing a configuration of a charging control system according to the first embodiment. FIG. 2 is a schematic plan view of a parking lot to which the charging control system according to the first embodiment is applied. FIG. 3 is a side view schematically showing charging of a battery electric vehicle EV1 parked in a parking space P11 using a charging and discharging apparatus CD1.

As shown in FIG. 1, the charging control system according to the present embodiment includes charging and discharging apparatuses CD1 to CD3 and a control apparatus 100. Here, the control apparatus 100 includes a deterioration information acquisition unit 101 and a priority determination unit 102.

As an example, in the charging control system shown in FIG. 1, the battery electric vehicles EV1 to EV3 parked in the parking spaces P11 to P13 shown in FIG. 2 are charged power from a power system (not shown) using the charging and discharging apparatuses CD1 to CD3. On the other hand, the charging control system shown in FIG. 1 is a virtual power plant adapted to supply power to the power system from the charged battery electric vehicles EV1 to EV3 via the charging and discharging apparatuses CD1 to CD3. The battery electric vehicle may be provided with a rechargeable battery that is rechargeable by a charging and discharging apparatus, and examples of such battery electric vehicle include HEV: Hybrid Electric Vehicle.

As shown in FIG. 1, each of the charging and discharging apparatuses CD1 to CD3 is connected to a power system, for example, and performs charging of the battery electric vehicles EV1 to EV3. Here, before charging a battery electric vehicle EV, the charging and discharging apparatus CD1 acquires, from the battery electric vehicle EV1, high-rate deterioration information hd1 of the battery of the battery electric vehicle EV1. Similarly, each of the charging and discharging apparatuses CD2 and CD3 acquires, from the battery electric vehicle EV2 and EV3, high-rate deterioration information hd2 and hd3 of the battery of the battery electric vehicles EV2 and EV3.

The high-rate deterioration information hd1 to hd3 of the battery shown in FIG. 1 is, for example, an evaluation value ED (integrated value of amount of damage D) disclosed in Patent Literature 2. Here, as disclosed in Patent Literature 2, the amount of damage D is caused by the uneven salt concentration in the battery, and can be calculated based on the current input and output to and from the battery and the duration of energization. Such battery high-rate deterioration information hd1 to hd3 is calculated by, for example, a battery controller (not shown) installed in each of the battery electric vehicles EV1 to EV3.

As described above, high-rate deterioration is transient deterioration caused by charging and discharging of a large current, and there are two types, an overcharging type and an overdischarging type. For example, in the case of high-rate deterioration of an overcharging type, the evaluation value ΣD is negative, and in the case of high-rate deterioration of an overdischarging type, the evaluation value ΣD is positive. The larger the absolute value of the evaluation value ΣD is, the larger the degree of high-rate deterioration (hereinafter referred to as a high-rate deterioration degree) is.

As shown in FIG. 1, each of the charging and discharging apparatuses CD1 to CD3 is wired or wirelessly connected to the control apparatus 100, and transmits the acquired high-rate deterioration information hd1 to hd3 to the control apparatus 100.

Then, the charging and discharging apparatuses CD1 to CD3 charge the battery electric vehicles EV1 to EV3, respectively, based on charging instructions ci1 to ci3 output from the control apparatus 100 which has acquired high-rate deterioration information hd1 to hd3. As described above, each of the charging and discharging apparatuses CD1 to CD3 is also a power receiving apparatus capable of receiving power from the charged battery electric vehicles EV1 to EV3, and can supply the received power to, for example, a power system.

Here, as shown in FIG. 2, in the charging control system according to this embodiment, the charging and discharging apparatuses CD1 to CD3 are installed in the parking spaces P11 to P13, respectively. The battery electric vehicles EV1 to EV3 shown in FIG. 1 are parked in the parking spaces P11 to P13 shown in FIG. 2, respectively, and are charged by the charging and discharging apparatuses CD1 to CD3, respectively.

More specifically, as shown in FIG. 3, a connector CN provided at the end of a cable CB extended from the charging and discharging apparatus CD1 is connected to a port PT of the battery electric vehicle EV1, and the battery electric vehicle EV1 is charged by the charging and discharging apparatus CD1. In the similar manner, the battery electric vehicles EV2 and EV3 are charged by the charging and discharging apparatuses CD2 and CD3, respectively. In similar manner, the charging and discharging apparatuses CD1 to CD3 receive power from the charged battery electric vehicles EV1 to EV3, respectively.

The parking lot shown in FIG. 2 is provided with three parking spaces (the parking spaces P11 to P13), but this is only an example, and the number of the parking spaces, the location of the charging and discharging apparatuses in each parking space, and the like are appropriately determined.

The control apparatus 100 controls the charging of the battery electric vehicles EV1 to EV3 by the charging and discharging apparatuses CD1 to CD3. Here, as shown in FIG. 1, the control apparatus 100 includes the deterioration information acquisition unit 101 and the priority determination unit 102.

As shown in FIG. 1, the deterioration information acquisition unit 101 acquires, from the charging and discharging apparatuses CD1 to CD3, the battery high-rate deterioration information hd1 to hd3 provided by the battery electric vehicles EV1 to EV3, respectively.

The priority determination unit 102 determines charging priorities of the battery electric vehicles EV1 to EV3 based on the high-rate deterioration information hd1 to hd3 acquired by the deterioration information acquisition unit 101.

Here, in the case of high-rate deterioration of an overcharging type, progression in deterioration of a battery occurs due to charging. On the other hand, in the case of high-rate deterioration of an overdischarging type, the high-rate deterioration due to charging is alleviated.

Therefore, the higher the high-rate deterioration degree of an overdischarging type in a battery of a battery electric vehicle is, the higher a charging priority is given to the battery electric vehicle equipped with the battery by the priority determination unit 102.

As shown in FIG. 1, the priority determination unit 102 transmits the charging instructions ci1 to ci3 to charging and discharging apparatuses CD1 to CD3 to which the battery electric vehicles EV1 to EV3 are connected to perform charging in an order of the charging priority. Then, charging and discharging apparatuses CD1 to CD3 that have received the charging instructions ci1 to ci3 charge the battery electric vehicles EV1 to EV3, respectively. That is, among the battery electric vehicles EV1 to EV3, the battery electric vehicle is charged in an order from a battery electric vehicle having a higher high-rate deterioration degree of an overdischarging type.

Although not shown in FIG. 1, the control apparatus 100 includes a computation unit such as a CPU (Central Processing Unit) and a memory such as a RAM (Random Access Memory) and a ROM (Read Only Memory) in which various programs and various data including the aforementioned maps are stored. That is, the control apparatus 100 has a function as a computer and executes various processing based on the various programs.

Therefore, the deterioration information acquisition unit 101 and the priority determination unit 102 included in the control apparatus 100 have a hardware configuration configured of the aforementioned CPU, memory, and other circuits. The deterioration information acquisition unit 101 and the priority determination unit 102 can be realized as software by a program stored in a memory. That is, the deterioration information acquisition unit 101 and the priority determination unit 102 can be realized in various forms of hardware, software, or a combination of both.

In addition to the high-rate deterioration information hd1 to hd3, the deterioration information acquisition unit 101 may further acquire SOH (State of Health) information of the batteries provided by each of the battery electric vehicles EV1 to EV3. The SOH information is also calculated by a battery controller included in each of the battery electric vehicles EV1 to EV3, for example, in the same manner as the high-rate deterioration information hd1 to hd3.

When the charging priorities based on the high-rate deterioration degrees are the same, the priority determination unit 102 gives the higher charging priority to the battery electric vehicle equipped with the battery having the higher SOH. By using a battery having high SOH, the SOH of the batteries in the battery electric vehicles EV1 to EV3 can be leveled.

As described above, the charge control system according to the present embodiment acquires high-rate deterioration information of the batteries each of the plurality of battery electric vehicles, and determines the charging priority of each of the plurality of the battery electric vehicles based on the acquired high-rate deterioration information. When determining the priority, the higher the high-rate deterioration degree of an overdischarging type in a battery of a vehicle, the battery electric vehicle equipped with the battery is given a higher charging priority.

That is, the battery that has been high-rate deteriorated, the deterioration being an overcharging-type, is less apt to be charged, and the battery that has been under high-rate deteriorated, the deterioration being an overdischarging type, is preferentially charged. Therefore, it is possible to alleviate high-rate deterioration in the battery.

The charge control system according to the present embodiment does not have to be a virtual power plant, and instead of charging and discharging apparatuses CD1 to CD3, a charging apparatus that performs only charging may be used.

Further, in the charge control system according to the present embodiment, for example, one charging and discharging apparatus may be shared by a plurality of battery electric vehicles. In such a case, for example, each of the plurality of the battery electric vehicles is capable of autonomous traveling, and charging thereof is performed by having each vehicle travel autonomously to one charging and discharging apparatus in an order from a battery electric vehicle that is given a higher charging priority. For example, the deterioration information acquisition unit 101 may acquire high-rate deterioration information hd1 to hd3 directly from the battery electric vehicles EV1 to EV3 without an intervention of the charging and discharging apparatus. The priority determination unit 102 may also transmit the charging instructions ci1 to ci3 that are based on the determined charging priorities to the battery electric vehicles EV1 to EV3.

### <Charging Control Method>

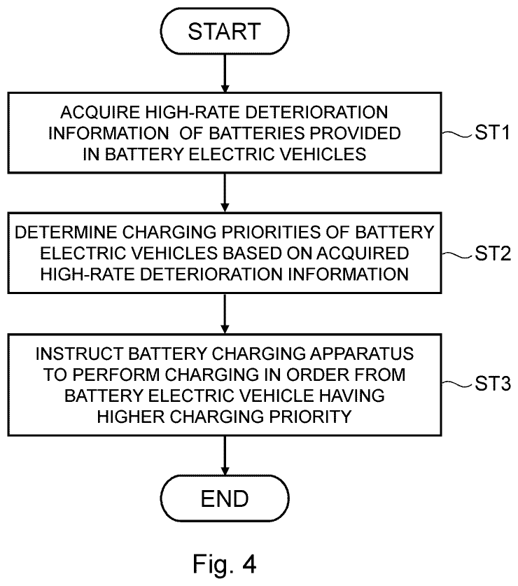

Next, a charging control method according to the first embodiment will be described with reference to FIG. 4. FIG. 4 is a flowchart showing a charging control method according to the first embodiment. First, as shown in FIG. 4, the deterioration information acquisition unit 101 of the control apparatus 100 shown in FIG. 1 acquires the high-rate deterioration information hd1 to hd3 of the batteries provided by the battery electric vehicles EV1 to EV3, respectively (Step ST1).

Next, as shown in FIG. 4, the priority determination unit 102 of the control apparatus 100 shown in FIG. 1 determines the charging priorities of the battery electric vehicles EV1 to EV3 based on the acquired high-rate deterioration information hd1 to hd3 (Step ST2). In Step ST2, the higher the high-rate deterioration degree of an overdischarging type in a battery of a battery electric vehicle, the battery electric vehicle equipped with the battery is given a higher charging priority by the priority determination unit 102.

Finally, as shown in FIG. 4, the priority determination unit 102 instructs the battery charging apparatus to perform charging of the battery electric vehicles EV1 to EV3 in an order from the battery electric vehicle that is given a higher charging priority (Step ST3). In the example shown in FIG. 1, the priority determination unit 102 transmits the charging instructions ci1 to ci3 to the charging and discharging apparatuses CD1 to CD3 to which the battery electric vehicles EV1 to EV3 are connected instructing the charging and discharging apparatuses to perform charging of the battery vehicles in an order from the battery vehicles that is given a higher charging priority. Then, the charging and discharging apparatuses CD1 to CD3 that have received the charging instructions ci1 to ci3 perform charging of the battery electric vehicles EV1 to EV3. That is, among the battery electric vehicles EV1 to EV3, the battery electric vehicle is charged in an order from the battery electric vehicle having the higher high-rate deterioration degree of an overdischarging type in a battery.

As described above, in the charging control method according to the present embodiment, high-rate deterioration information of the battery provided by each of the plurality of battery electric vehicles is acquired, and the charging priorities of the plurality of the battery electric vehicles are determined based on the acquired high-rate deterioration information. When the priority is determined, the higher the high-rate deterioration degree of an overdischarging type in a battery, the battery electric vehicle including the battery is given a higher charging priority.

That is, the battery that has been high-rate deteriorated, the deterioration being an overcharging type, is less apt to be charged, and the battery that has been high-rate deteriorated, the deterioration being an overdischarging type, is preferentially charged. Therefore, it is possible to alleviate high-rate deterioration in the battery.

The present disclosure promotes the use of battery electric vehicles and contributes to carbon neutrality, decarbonization, and Sustainable Development Goals (SDGs).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A charging control system comprising:
a charging apparatus for charging a battery electric vehicle; and
a control apparatus for controlling charging of a plurality of the battery electric vehicles by the charging apparatus,
wherein the control apparatus includes:
a deterioration information acquisition unit configured to acquire high-rate deterioration information of a battery provided by each of the plurality of the battery electric vehicles; and
a priority determination unit configured to determine a charging priority of each of the plurality of the battery electric vehicles based on the high-rate deterioration information acquired by the deterioration information acquisition unit,
wherein the higher the high-rate deterioration degree of an overdischarging type in the battery is, the higher a charging priority is given to the battery electric vehicle provided with the battery by the priority determination unit.

2. The charging control system according to claim 1, wherein
the deterioration information acquisition unit further acquires SOH (State of Health) information of the battery, and
when the charging priorities based on the high-rate deterioration degrees are the same, the priority determination unit gives a higher charging priority to the battery electric vehicle provided with the battery having a higher SOH.

3. The charging control system according to claim 1, wherein
the charging apparatus is connected to a power system, and
a plurality of the battery electric vehicles charged by the charging apparatus constitute a virtual power plant capable of supplying power to the power system.

4. A charging control method for causing a computer to control charging of a plurality of battery electric vehicles, comprising:
acquiring high-rate deterioration information of a battery provided by each of the plurality of the battery electric vehicles; and
determining a charging priority of each of the plurality of the battery electric vehicles based on the acquired high-rate deterioration information,
wherein in determining the charging priority, the higher the high-rate deterioration degree of an overdischarging type in the battery is, the higher a charging priority is given to the battery electric vehicle provided with the battery by the priority determination unit.
